(19) United States
(12) Patent Application Publication
(10) Pub. No.: US 2026/0071618 A1
(43) Pub. Date: Mar. 12, 2026

(54) COMPRESSOR SYSTEMS FOR PUNCTURE REPAIR KITS

(71) Applicant: Continental Reifen Deutschland GmbH, Hannover (DE)

(72) Inventors: Florian Schlosser, Barsinghausen (DE); Rainer Detering, Neustadt am Rübenberge (DE)

(73) Assignee: Continental Reifen Deutschland GmbH, Hannover (DE)

(21) Appl. No.: 19/101,864

(22) PCT Filed: Jul. 13, 2023
(86) PCT No.: PCT/DE2023/200146

§ 371 Date: Feb. 6, 2025

(30) Foreign Application Priority Data
Aug. 9, 2022 (DE) 10 2022 208 268.0

(51) Int. Cl. F04B 37/12; B29C 73/02; F04B 35/04; F04B 49/16

(52) U.S. Cl. CPC F04B 37/12; B29C 73/025; F04B 35/04; F04B 49/16

(57) ABSTRACT

A compressor system for a puncture repair kit with a piston which is driven by a motor via a crank mechanism, and a cylinder main body having a pump chamber, in which the piston is mounted movably from a bottom dead center to a top dead center in order to compress air. The cylinder main body is a plastic component. and has a metal insert in the region of the air outlet valve.

The invention relates to a compressor system for a puncture repair kit with a piston driven by a motor via a crank mechanism with two gearwheels and a cylinder main body having a pump chamber, in which the piston is mounted movably from a bottom dead center to a top dead center in order to compress air. Furthermore, the invention relates to a puncture repair kit comprising a compressor system, and to a method for sealing a vehicle tire.

Compressor systems for puncture repair kits of the type described above are known for the use of passenger car tires. Such puncture repair kits are designed to provide the volume of compressed air necessary for a passenger car tire in a specified time at a required pressure. Known compressor systems for puncture repair kits are not designed for vehicle tires, for example of a van or a truck, which have a greater volume and/or a higher filling pressure. The volume flow provided is too low to fill such a vehicle tire in an allocated time. The necessary long operating time would regularly lead to overheating of the compressor system, with the necessary filling pressures not being achieved by known compressor systems. This is due to the fact that known compressor systems are made of plastics with the aim of achieving a low weight and a small overall size.

US 2020/0158099 A1 discloses such a compressor system made of plastic, wherein the air outlet end component of the cylinder, which is releasably connected to the outlet unit, has a metal insert to enhance this region for the high pressures and temperatures prevailing there.

Against this background, the invention is based on the object of providing a compressor system for a puncture repair kit of the type mentioned at the outset in a reliable and cost-efficiently produceable design with a low weight and a small overall size, which enables a higher volume flow and a higher filling pressure when filling vehicle tires.

This object is achieved by way of a compressor system according to the features of claim 1, a puncture repair kit and a method as claimed in the further independent claims. The subclaims relate to particularly expedient developments of the invention.

According to the invention, therefore, a compressor system for a puncture repair kit is provided, comprising a motor, a piston which is driven by the motor via a crank mechanism, and a single-part cylinder main body having a pump chamber, in which the piston is mounted movably from a bottom dead center to a top dead center in order to compress air, and a receiving chamber for receiving the compressed air compressed in the pump chamber through an air outlet valve, wherein the cylinder main body is a plastic component, wherein the cylinder main body has a metal insert in the region of the air outlet valve.

It was advantageously recognized that a single-part cylinder main body which forms the pump chamber and the receiving chamber is particularly reliable with a small size and thus with a low weight. Due to the single-part design of the region which is exposed to high pressure and high temperatures, there is no need to connect and seal a plurality of components in this region. Due to the prevailing pressures and the resulting forces, plastic flanges must be of large dimensions at the prevailing temperatures in order to enable a tight connection which is as durable as possible.

The cylinder main body has a metal insert in the region of the air outlet valve, since it has been recognized that the highest temperatures and a high flow velocity are reached in this region, with the result that, for a plastic, a high thermal load is present, and at the same time a high mechanical load due to the high flow velocity and the prevailing pressure. Known plastics cannot withstand these loads in the relatively long term without damage. Known compressors designed for the required pressures and volume flows are made of metal and therefore have a larger overall size and a significantly higher weight.

According to the invention, it has been recognized that a single-part cylinder main body made of plastic is suitable to provide a low-weight compressor system which allows higher filling pressures than in known compressor systems of this type at a high volume flow rate, if it has a metal insert in the particularly loaded region. The metal insert preferably consists of an iron alloy, a zinc alloy or an aluminum alloy.

A single-part cylinder main body is understood to mean that the cylinder main body does not consist of a plurality of components that form sealing surfaces with respect to each other or that must be dismantled in the event of maintenance or repair. However, a single-part cylinder main body consists of various materials, such as a plastic and a metal insert, and preferably glass fibers. Preferably, the metal insert is overmolded by the plastic of the cylinder main body. However, the metal insert may alternatively be permanently connected to the plastic using other known means in order to form the single-part cylinder main body.

One preferred embodiment provides that the plastic at least of the cylinder main body is a glass fiber-reinforced plastic, preferably having a glass fiber content of from 40% to 60% and further preferably of from 45% to 50%, and is preferably a polyamide. Plastics with a glass fiber content of at least 40% and not more than 60% are particularly suitable for use as cylinder main bodies due to their high mechanical and thermal loadbearing capacity. Polyamide in particular has proved to be a suitable plastic. Preferably, at least the other highly loaded components also have such a glass fiber content.

Another preferred embodiment provides that the metal insert is enclosed in a positively locking manner by the plastic of the cylinder main body and further preferably extends with partial regions as far as through the outer surfaces of the plastic of the cylinder main body. A positively locking enclosure of the metal insert by the plastic ensures a secure connection between the metal insert and the plastic, even under high thermal and mechanical loads. Partial regions of the metal insert that protrude from the plastic of the cylinder main body into the surroundings allow effective heat dissipation to the surroundings. In particular, the partial regions can be designed as cooling fins and positioned in a region of increased air circulation.

Another preferred embodiment provides that the air outlet valve is a check valve, in particular a reed valve. Check valves are air outlet valves that are reliable, can be produced inexpensively, and have proved suitable, in particular, up to medium gas exchange frequencies. Reed valves are preferably used, as they are particularly efficient, i.e. generate low return flow losses, and are light. In particular, reed valves allow effective gas exchange even at higher gas exchange frequencies.

Another preferred embodiment provides that the crank mechanism comprises gearwheels, wherein the gearwheels consist of metal at least in partial regions, preferably exclusively. Plastic gearwheels have a low durability at the high pressures to be generated at a high volume flow rate and the therefore high power to be transmitted, if they have the necessary compact overall design. It has proven to be advantageous to manufacture the particularly loaded partial regions, such as the teeth of the gearwheels, from a metal, as this enables a compact overall design and durably reliable operation. Gearwheels which consist only of metal have proven to be particularly resistant and inexpensive.

Another preferred embodiment provides that, in order to limit a maximum pressure in the pump chamber, the pump chamber forms a dead space volume, in particular a variable dead space volume dependent on the pressure in the pump chamber. The limitation of the maximum pressure in the pump chamber by means of a dead space volume enables an inexpensive and reliable limitation of the maximum pressure. This way of limiting the maximum pressure is still more efficient at high pressures than blowing off the compressed air via a relief valve. This reduces the temperature load in the pump chamber, especially at high thermal and mechanical loads which are present at high pressures. In operating conditions in which no limitation of the pressure is necessary, the dead space volume reduces efficiency. Therefore, a dead space volume which is dependent on the pressure in the pump chamber, i.e. increases at high pressures, is preferred, since this increases the efficiency at lower pressures, whereby lower heating of the pump chamber is achieved, with the result that the maximum temperature reached when filling a vehicle tire is reduced. A variable dead space can be formed, for example, by a second, spring-loaded piston, which is attached to the pump chamber in parallel to the air outlet valve, or by means of elastic side walls of the pump chamber.

Another preferred embodiment provides that the cylinder main body is suitable to provide a maximum pressure of at least 7 bar, preferably of at least 8 bar, further preferably of at least 9 bar and most preferably of at least 10 bar, wherein there are temperatures of at least 150° C., preferably of at least 170° C., further preferably of at least 190° C., further preferably of at least 220° C. and most preferably of at least 250° C. in regions of the cylinder main body. A cylinder main body, which is suitable to provide at least a maximum pressure of 7 bar at temperatures of at least 150° C. makes a compressor system for puncture repair kits possible, which can generate higher filling pressures at high volume flows. If the cylinder main body is suitable for even higher pressures and temperatures, even higher filling pressures can be generated at high volume flows. Higher filling pressures are understood to mean, in particular, a filling pressure in the vehicle tire of at least 3 bar, preferably of at least 4 bar and further preferably of at least 5 bar.

According to the invention, a puncture repair kit comprising a compressor system according to the invention and a sealant device is provided, wherein the sealant device has a sealant for sealing a vehicle tire, wherein the compressor system can preferably be connected to the sealant device. The puncture repair kit according to the invention enables the sealing and filling of a vehicle tire with a higher filling pressure, wherein the compressor system is advantageous, in particular, in its use as a puncture repair kit, since puncture repair kits have to have a low weight and a small overall size.

According to the invention, a method for sealing a vehicle tire using a compressor system according to the invention or a puncture kit according to the invention is provided, comprising at least the following steps:
i) building up a positive pressure by a piston in the compressor system, wherein the positive pressure in the cylinder main body is at least 8 bar, preferably at least 9 bar and further preferably at least 10 bar,
ii) delivering a sealant into a vehicle tire by means of a positive pressure built up in the compressor system.

The method according to the invention for sealing a vehicle tire with a sealant is advantageous, since, by the high pressures that can be generated in the cylinder main body, vehicle tires can be filled with higher pressures at a high volume flow rate and can preferably be sealed.

The invention permits numerous embodiments. To further illustrate its basic principle, one of these embodiments is illustrated in the drawing and will be described in the following text. In the drawing:

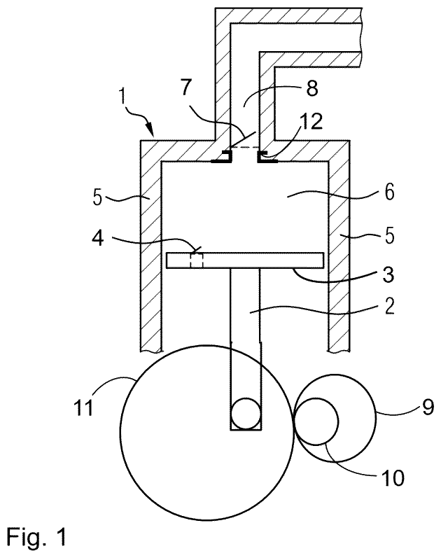

FIG. 1 shows a compressor system for a puncture repair kit.

FIG. 1 shows a compressor system for a puncture repair kit with a single-part cylinder main body 1 which receives a piston 3 driven by a connecting rod 2 with an air inlet valve 4 within side walls 5 of a pump chamber 6. The cylinder main body 1 comprises an air outlet valve 7 which prevents the compressed air from flowing back from the receiving chamber 8.

If the motor 9 drives a second gearwheel 11 via a first gearwheel 10, the connecting rod 2 moves the piston 3 in the direction of the bottom dead center, with the result that air flows through the open air inlet valve 4 into the pump chamber 6 with the air outlet valve 7 closed. After the bottom dead center is passed through, the air in the pump chamber 6 is compressed with the air inlet valve 4 closed and conveyed through the opening air outlet valve 7.

The air, which is heated by the compression, reaches its maximum temperature when reaching the top dead center, wherein the highest thermal load of the cylinder main body 1 is produced by the produced flow in the region of the narrowing pump chamber 6 immediately upstream of the air outlet valve 7 in the flow direction. The highest mechanical load simultaneously prevails in this region of the pump chamber 6 due to the pressure. In order to withstand this thermal and mechanical load, the cylinder main body 1, which consists predominantly of a glass fiber-reinforced plastic, has, in this region, a metal insert 12 which forms the surface of the cylinder main body 1 in the highly loaded region. The metal insert 12 is formed in one part with the plastic of the cylinder main body 1 and is connected to the latter in a positively locking manner by an injection molding process.

### LIST OF DESIGNATIONS

1 Cylinder main body
2 Connecting rod
3 Piston
4 Air inlet valve
5 Side walls
6 Pump chamber
7 Air outlet valve
8 Receiving chamber
9 Motor
10 First gearwheel
11 Second gearwheel
12 Metal insert

1. A compressor system for a puncture repair kit comprising
a motor,
a piston which is driven by the motor via a crank mechanism, and
a single-part cylinder main body having a pump chamber, in which the piston is mounted movably from a bottom dead center to a top dead center in order to compress air, and a receiving chamber for receiving the compressed air compressed in the pump chamber through an air outlet valve,
wherein the cylinder main body is a plastic component,
wherein the cylinder main body has a metal insert in the region of the air outlet valve.

2. The compressor system as claimed in claim 1, wherein the plastic at least of the cylinder main body is a glass fiber-reinforced plastic, preferably having a glass fiber content of from 40% to 60% and more preferably of from 45% to 50%, and is preferably a polyamide.

3. The compressor system as claimed claim 1, wherein the metal insert is enclosed in a positively locking manner by the plastic of the cylinder main body and preferably extends with partial regions as far as through the outer surfaces of the plastic of the cylinder main body.

4. The compressor system as claimed in claim 1, wherein the air outlet valve is a check valve, in particular a reed valve.

5. The compressor system as claimed in claim 1, wherein the crank mechanism comprises gearwheels, which consist of metal at least in partial regions, preferably exclusively.

6. The compressor system as claimed in claim 1, wherein, in order to limit a maximum pressure in the pump chamber, the pump chamber forms a dead space volume, in particular a variable dead space volume dependent on the pressure in the pump chamber.

7. The compressor system as claimed in claim 1, wherein the cylinder main body is suitable to provide a maximum pressure of at least 7 bar, preferably of at least 8 bar, further preferably of at least 9 bar and most preferably of at least 10 bar, wherein there are temperatures of at least 150° C., preferably of at least 170° C., further preferably of at least 190° C., further preferably of at least 220° C. and most preferably of at least 250° C. in regions of the cylinder main body.

8. A puncture repair kit comprising a compressor system as claimed in claim 1 and a sealant device, wherein the sealant device has a sealant for sealing a vehicle tire, wherein the compressor system can preferably be connected to the sealant device.

9. A method for sealing a vehicle tire using a compressor system as claimed in claim 1, comprising at least the following steps:
i) building up a positive pressure by a piston in the compressor system, wherein the positive pressure in the cylinder main body is at least 8 bar, preferably at least 9 bar and further preferably at least 10 bar,
ii) delivering a sealant into a vehicle tire by means of a positive pressure built up in the compressor system.
